(19) United States
(12) Patent Application Publication
(10) Pub. No.: US 2012/0158899 A1
(43) Pub. Date: Jun. 21, 2012

(54) INFORMATION MANAGEMENT METHOD AND MOBILE DEVICE ADAPTED TO THE METHOD

(75) Inventor: Jin Hong JEONG, Yongin-si (KR)

(73) Assignee: SAMSUNG ELECTRONICS CO. LTD., Suwon-si (KR)

(21) Appl. No.: 13/325,604

(22) Filed: Dec. 14, 2011

(30) Foreign Application Priority Data
Dec. 15, 2010 (KR) 10-2010-0128222

(51) Int. Cl. G06F 15/16

(52) U.S. Cl. 709/217

(57) ABSTRACT

An information managing method and a mobile device adapted to the method are provided. When the mobile device operates in a style hub mode to manage a style serving as the environment of the mobile device, at least one piece of style information serving as a basic property forming the style is created. When a style registration is selected, the created style information is uploaded to a style sharing network connected to the mobile device. Users can set the environment of their mobile devices to a desired environment.

### PRIORITY

This application claims the benefit under 35 U.S.C. §119(a) of a Korean patent application filed on Dec. 15, 2010 in the Korean Intellectual Property Office and assigned Serial No. 10-2010-0128222, the entire disclosure of which is hereby incorporated by reference.

### BACKGROUND OF THE INVENTION

1. Field of the Invention

The present invention relates to mobile devices and methods for managing information in the mobile devices. More particularly, the present invention relates to a mobile device and a method for managing style information so users can set an environment of the mobile device according to their preference.

2. Description of the Related Art

With rapid technology advancement, mobile devices now serve as multimedia communication devices so that they can provide a variety of services, such as electronic organizers, games, schedule management, etc. As mobile devices, for example, smartphones, become widely used, the variety of contents also increases.

FIG. 1 illustrates an application consumption process according to the related art.

Referring to FIG. 1, contents providers 110a, 110b, and 110c wirelessly provide applications to an application store 120. Users download and use applications from the application store 120. Users are divided into heavy users 130, medium users 140, and light users 150. Heavy users 130 refer to a few users who are very interested in mobile devices, are good at handling mobile devices, and consume most applications. Medium users 140 and light users 150 consume applications according to the heavy users' application consumption patterns.

However, heavy users require a great deal of time to search for applications, alter background images and icons, etc. in order to change one environment to another set in their mobile devices. Since it requires a great deal of time to change one environment to another in their mobile devices, heavy users tend to retain the original environment rather than use new applications.

Medium users and light users tend to follow heavy users' application consumption pattern. In that case, medium users and light users may use applications in the heavy users' application pattern that they did not intend to use.

Therefore, there is a need for an information managing method for setting environments of a mobile device according to users and a mobile device adapted to the information managing method.

### SUMMARY OF THE INVENTION

Aspects of the present invention are to address at least the above-mentioned problems and/or disadvantages and to provide at least the advantages described below. Accordingly, an aspect of the present invention is to provide an information managing method for setting environments of a mobile device according to users.

In accordance with an aspect of the present invention, a method for managing information in a mobile device is provided. The method includes creating, when the mobile device operates a style hub mode to manage a style serving as an environment of the mobile device, at least one piece of style information serving as a basic property forming the style, displaying a style corresponding to the created style information, and uploading, when a style registration is selected, style information corresponding to the displayed style to a style sharing network connected to the mobile device.

In accordance with an aspect of the present invention, a data mobile device is provided. The mobile device includes a controller for creating, when the mobile device operates a style hub mode to manage a style serving as an environment of the mobile device, at least one piece of style information forming the style, and for uploading, when a style registration is selected, the created style information to a style sharing network connected to the mobile device, a communication unit for connecting to the style sharing network under the control of the controller, a storage unit for storing the style information under the control of the controller, and a display unit for displaying a style corresponding to the style information under the control of the controller.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects features, and advantages of the present invention will be more apparent from the following description taken in conjunction with the accompanying drawings, in which:

FIG. 1 illustrates an application consuming process according the related art;

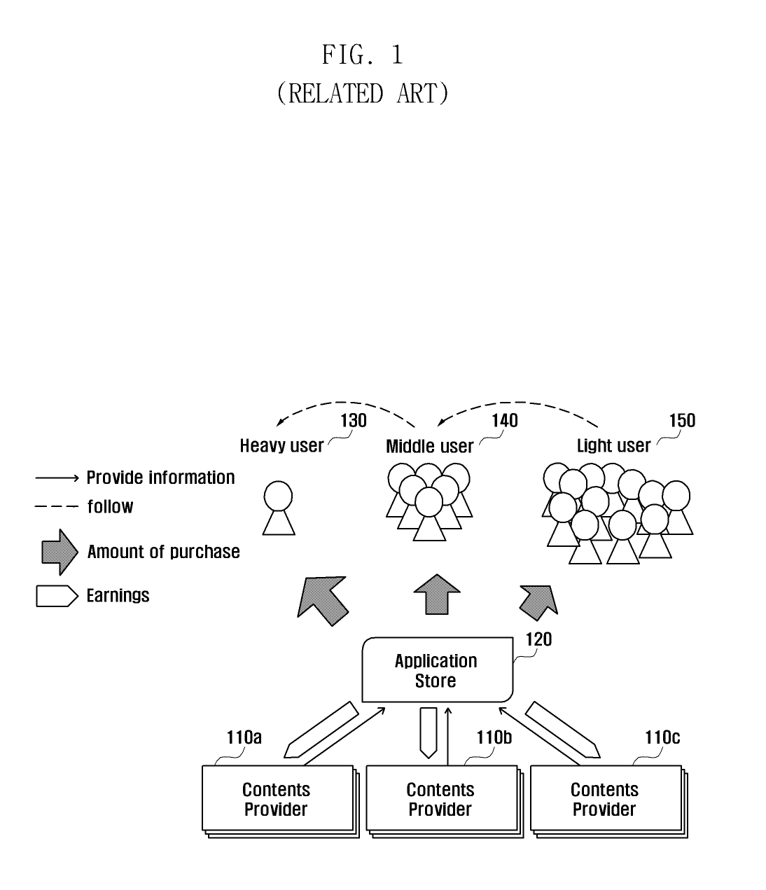

FIG. 2 is a flowchart illustrating a method for transmitting/receiving style information via a style sharing system according to an exemplary embodiment of the present invention;

FIG. 3 illustrates a schematic block diagram of a mobile device according to an exemplary embodiment of the present invention;

FIG. 4 illustrates a screen of a mobile device for managing styles according to an exemplary embodiment of the present invention;

FIG. 5 illustrates a screen of a mobile device for setting a style according to an exemplary embodiment of the present invention;

FIG. 6 illustrates a screen of a mobile device for selecting a style exhibition set in the mobile device according to an exemplary embodiment of the present invention;

FIG. 7 illustrates a screen of a mobile device for selecting a style information upload according to an exemplary embodiment of the present invention;

FIG. 8 illustrates a screen of a mobile device for selecting style information to be uploaded according to an exemplary embodiment of the present invention;

FIG. 9 illustrates a screen of a mobile device for selecting a style edition according to an exemplary embodiment of the present invention;

FIG. 10 is a flowchart illustrating a method for managing style information in a mobile device according to an exemplary embodiment of the present invention;

FIG. 11 is a flowchart illustrating a method for setting style information in a mobile device according to an exemplary embodiment of the present invention;

FIG. 12 is a flowchart illustrating a method for downloading style information in a mobile device according to an exemplary embodiment of the present invention; and

FIG. 13 is a flowchart illustrating a method for managing style information in a style sharing network according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Particular terms may be defined herein to describe the invention in the best manner. Accordingly, the meaning of specific terms or words used in the specification and the claims should not be limited to the literal or commonly employed sense, but should be construed in accordance with the spirit of the invention.

The term ‘mobile devices’ refers to information processing devices that can process information created by users or information transmitted/received to/from external systems. In an exemplary embodiment of the present invention, mobile devices may be smartphones.

The term ‘style’ refers to an environment of a mobile device that is displayed on the screen. In an exemplary embodiment of the present invention, the environment of a mobile device includes a background image, menus, widgets, icons, systems volume, etc. that the mobile device manufacturer provided during manufacture.

The term ‘style information’ refers to information regarding the basic property for the environment of a mobile device. In an exemplary embodiment of the present invention, style information includes information regarding paid applications that are downloaded to a mobile device via a network, such as an Application (APP) store.

The term ‘style hub mode’ refers to a mode where the environment of a mobile device is managed according to a user's selection. In the style hub mode, styles are created, registered, edited, etc.

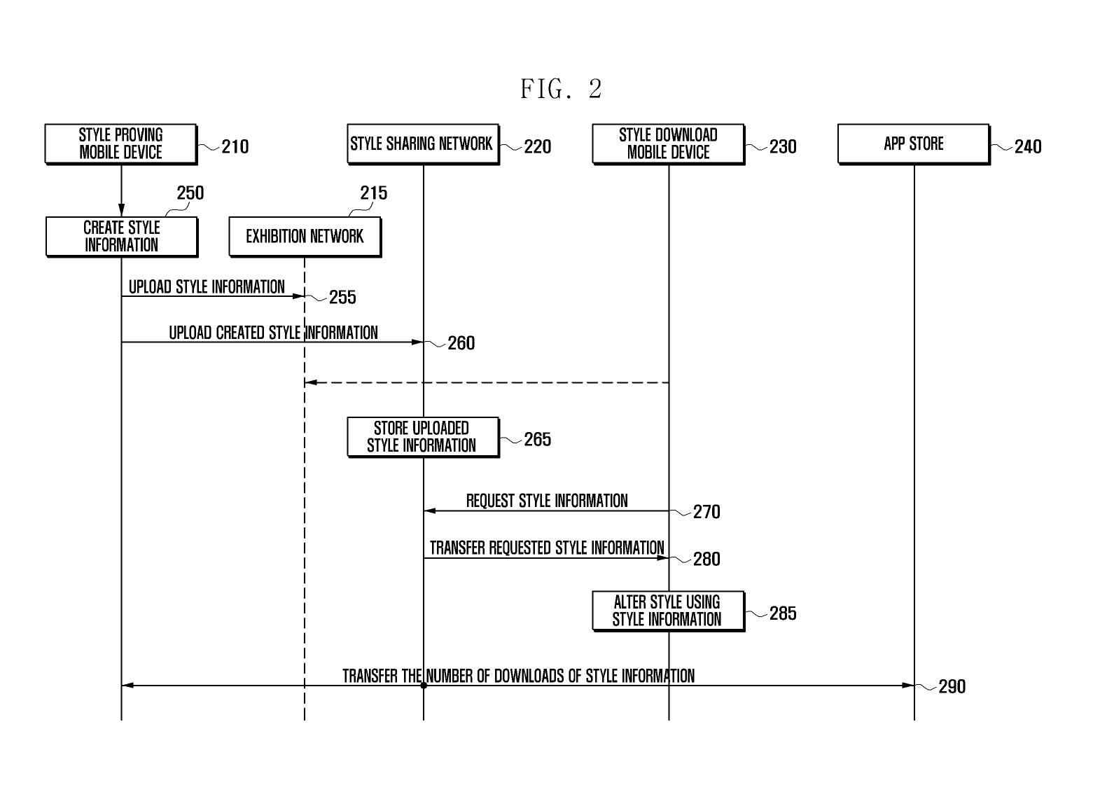

FIGS. 2 through 13, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 2 is a flowchart illustrating a method for transmitting/receiving style information via a style sharing system according to an exemplary embodiment of the present invention.

Referring to FIG. 2, the style sharing system includes a style providing mobile device 210, an exhibition network 215, a style sharing network 220, a style download mobile device 230, and an application store (APP store) 240.

The style providing mobile device 210 registers style information, created according to the environment set in a mobile device, in the exhibition network 215 and the style sharing network 220.

The exhibition network 215 represents a blog/Social Networking Service (SNS) that cooperates with the style providing mobile device 210 in order to inform other users of a created style. In an exemplary embodiment of the present invention, a mobile device registers created style information in a blog/SNS according to a user's selection, so that other users can view the style, created in the mobile device, via the blog/SNS.

The style sharing network 220 stores style information transmitted from the style providing mobile device 210 and also transfers stored style information to a mobile device when the mobile device requests it. The style sharing network 220 identifies the number of downloads of style information and then divides the rewards among the beneficiaries according to the style download to users who registered the style information.

The style download mobile device 230 refers to a mobile device that downloads styles registered by other users from the style sharing network 220 according to the user's selection.

The APP store 240 provides free or paid applications available for mobile devices. Although this exemplary embodiment of the present invention is implemented in such a manner that the APP store 240 is separated from the style sharing network 220, it should be understood that the present invention is not limited to this exemplary embodiment. For example, the APP store 240 may be included in the style sharing network 220. Alternatively, the APP store 240 may include the style sharing network 220.

Referring to FIG. 2, the style providing mobile device 210 creates information corresponding to a style, serving as the environment of a mobile device, according to a user's selection at step 250. The style providing mobile device 210 uploads the style information in the exhibition network 215 at step 255. In that case, the user of the style download mobile device 230 can identify the created style. The process of uploading the style information to the exhibition network 215 may be omitted according to a user's selection.

Thereafter, the style providing mobile device 210 uploads the created style information to the style sharing network 220 according to a user's selection at step 260. During this uploading process, the style providing mobile device 210 may also transfer a user's identification, phone number, or Internet Protocol (IP) address of the mobile device, together with the created style information. In that case, the style sharing network 220 stores the uploaded style information at step 265.

The style download mobile device 230 requests style information from the style sharing network 220 according to a user's selection at step 270. More particularly, the style download mobile device 230 identifies styles registered in the exhibition network 215 and requests style information corresponding to a style from the style sharing network 220. In that case, the style sharing network 220 transfers the requested style information to the style download mobile device 230 at step 280. The style download mobile device 230 alters the style, serving as the environment of the mobile device, using the style information transferred from the style sharing network 220 at step 285.

The style sharing network 220 transfers the number of downloads of style information to the APP store 240 and the style providing mobile device 210 that uploaded corresponding style information, respectively at step 290. The rewards can be divided to the users of the style providing mobile device 210 that uploaded the style information, according to the number of downloads of style information.

Therefore, the style sharing system described above can allow the user to easily alter the environment of the mobile device. That is, the user can easily download a style and set the environment of the mobile device according to the downloaded style, without searching for an application included in the style from the APP store 240.

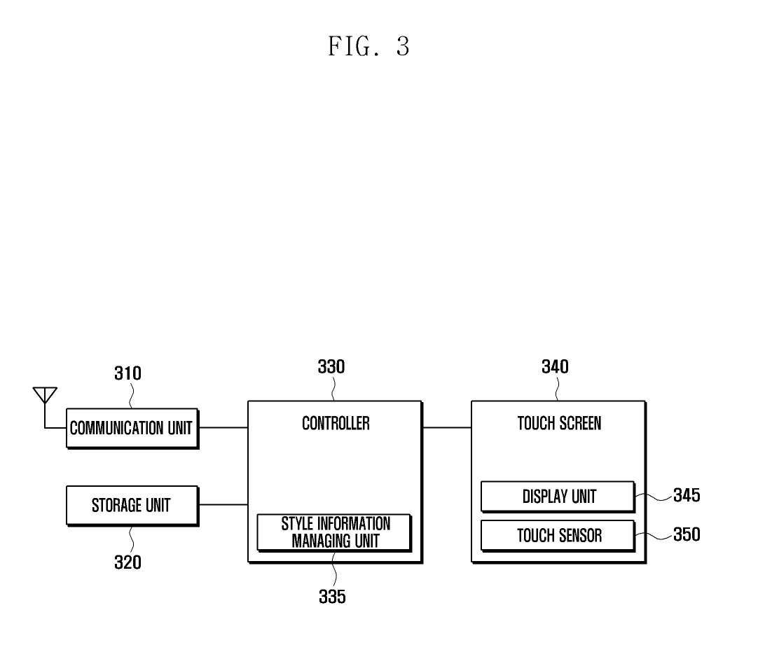

FIG. 3 illustrates a schematic block diagram of a mobile device according to an exemplary embodiment of the present invention.

Referring to FIG. 3, the mobile device includes a communication unit 310, a storage unit 320, a controller 330, and a touch screen 340.

The communication unit 310 performs communication with other external systems. For example, the communication unit 310 establishes a communication channel with a base station, and performs voice or video communication via the channel. Similarly, the communication unit 310 also performs data communication to transmit/receive text messages, image data, etc., to/from the base station via the channel. To this end, the communication unit 310 includes a Radio Frequency (RF) transmitter for up-converting the frequency of signals to be transmitted and amplifying the signals and an RF receiver for low-noise amplifying received RF signals and down-converting the frequency of the received RF signals.

The communication unit 310 can also establish a communication channel with networks and then perform data communication therethrough. More particularly, the communication unit 310 can be connected to an exhibition network or a style sharing network under the control of the controller 330. The communication unit 310 transfers information corresponding to a set style to the exhibition network or style sharing network under the control of the controller 330. The communication unit 310 can also receive at least one piece of style information from a style sharing network according to a user's selection under the control of the controller 330. The communication unit 310 can download a paid application included in a style from an APP store or a style sharing network under the control of the controller 330.

The storage unit 320 stores data created according to the operations and states of the components included in the mobile device, under the control of the controller 330. The storage unit 320 stores information corresponding to a style that is set by the user, under the control of the controller 330. The storage unit 320 stores identification-information of a style sharing network and an exhibition network to register style information under the control of the controller 330.

The controller 330 controls the entire operation of the components in the mobile device. The controller 330 can set a style, serving as the environment of the mobile device, according to a user's selection. To this end, the controller 330 includes a style information managing unit 335.

The style information managing unit 335 operates a style hub mode according to a user's selection. The style hub mode refers to a mode where the environment of a mobile device can be altered according to a user's settings. In a style hub mode, the mobile device creates or registers a style according to the user's selection or downloads styles, created by other users, according to the user's selection.

The style information managing unit 335 can register a style set according to a user's selection in an exhibition network or a style sharing network. More particularly, the style information managing unit 335 sets a style with basic properties forming the environment of the mobile device, according to a user's selection. The style information managing unit 335 controls the storage unit 320 to store information corresponding to the set style. The style information managing unit 335 controls a display unit 345 of the touch screen 340 to display the set style. Thereafter, the style information managing unit 335 uploads the style information, set according to a user's selection, to the exhibition network or style sharing network. Alternatively, the style information managing unit 335 may only upload style information selected by a user. The style information managing unit 335 can also upload a user's IDentification (ID) information, such as a user's ID or phone number, etc., to the style sharing network, when uploading the style information.

The style information managing unit 335 can download styles that other users have registered, according to a user's selection. To this end, the style information managing unit 335 controls the communication unit 310 to connect to a style sharing network. The style information managing unit 335 displays at least one style, received via the communication unit 310 from the style sharing network, in thumbnail form. Thereafter, the style information managing unit 335 downloads style information corresponding to a user's selected style from the style sharing network.

The style information managing unit 335 can edit styles according to a user's selection. More particularly, when the user selects a style edit, the style information managing unit 335 displays information regarding the style that is being currently set or is selected by the user. Thereafter, the style information managing unit 335 alters the style information according to a user's selection. The style information managing unit 335 stores the altered style information in the storage unit 320.

The controller 330 can manage the style information corresponding to a style, serving as an environment of the mobile device, via the style information managing unit 335. The controller 330 determines whether a paid application is included in the style information transferred from the style sharing network. When the controller 330 determines that a paid application is included in the style information transferred from the style sharing network, it determines whether the storage unit 320 stores the same application as the paid application. When the controller 330 determines that the storage unit 320 does not store the same application as the paid application, it controls the display unit 345 of the touch screen 340 to display the amount of money paid when a corresponding application is downloaded as well.

The touch screen 340 includes a display unit 345 and touch sensors 350. The display unit 345 displays the information related to the states and operations of the mobile device. The display unit 345 displays a style set by the user, under the control of the controller 330. The display unit 345 also displays styles transferred from the style sharing network, under the control of the controller 330.

The touch sensors are installed to the display unit 345, and detect events that occur on the display unit 345 when an object touches the display unit 345 or releases the touches therefrom.

The mobile device as described above can set a style for the environment, according to a user's selection. The mobile device can also register the information corresponding to a style that is set according to a user's selection in the style sharing network or exhibition network. The mobile device can reflect a style in its environment, downloaded from the style sharing network according to a user's selection. The mobile device can also edit and store a style downloaded according to a user's selection.

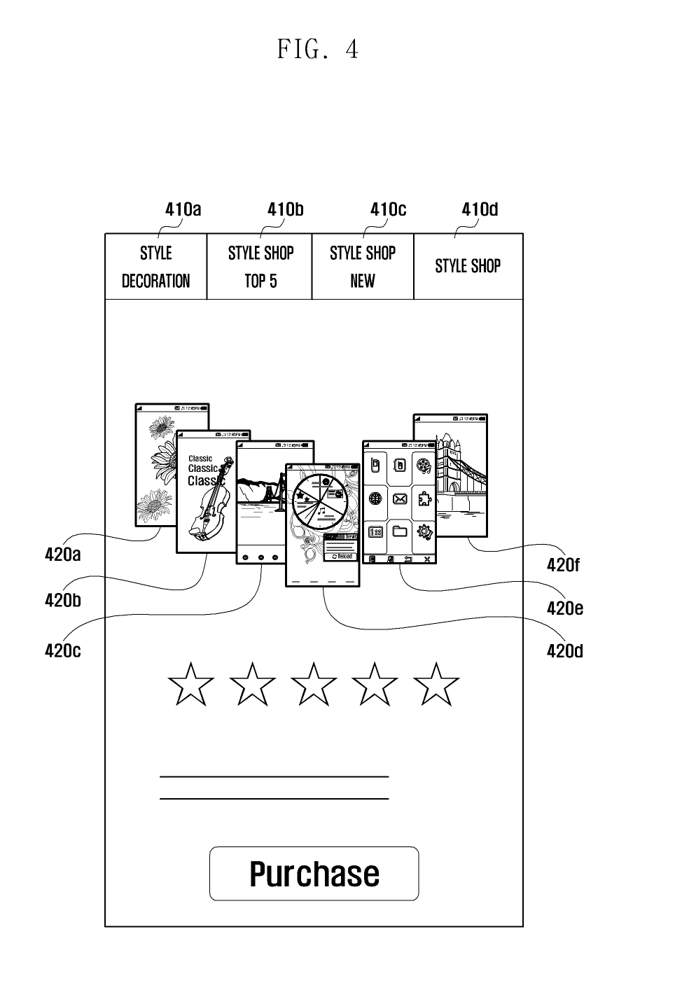

FIG. 4 illustrates a screen of a mobile device for managing styles according to an exemplary embodiment of the present invention.

Referring to FIG. 4, a user selects a style hub, comprised of menus or icons for managing an environment of the mobile device, from a menu bar or a widget tray. In that case, the mobile device operates a style hub mode, and then displays a style hub mode window for managing the environment on the screen as shown in FIG. 4.

A style hub mode window includes a style decoration 410a, a style shop TOP 5 410b, a style shop NEW 410c, and a style shop 410d. The style decoration 410a refers to a menu that sets the environment of the mobile device according to a user's preference. The style shop TOP 5 410b refers to a menu that displays one of the styles registered by other users, which is the most downloaded. The style shop NEW 410c refers to a menu that displays newly registered styles. The style shop 410d refers to a menu that displays all registered styles. When one of the style shop TOP 5 410b, style shop NEW 410c, and style shop 410d is selected, the styles displayed on the mobile device are downloaded, in the image format, from a style sharing network. The mobile device displays the downloaded styles on the display unit 345 in thumbnail form. For example, when the user selects the style shop NEW 410c, the mobile device displays at least one or more styles 420a, 420b, 420c, 420d, 420e, and 420f, in thumbnail form, as shown in FIG. 4.

Although this exemplary embodiment of the present invention is implemented in such a manner that the style hub menu window includes the menus shown in FIG. 4, it should be understood that the present invention is not limited to this exemplary embodiment. For example, the style hub menu window may further include a variety of menus according to mobile device manufacturers or networks providing styles.

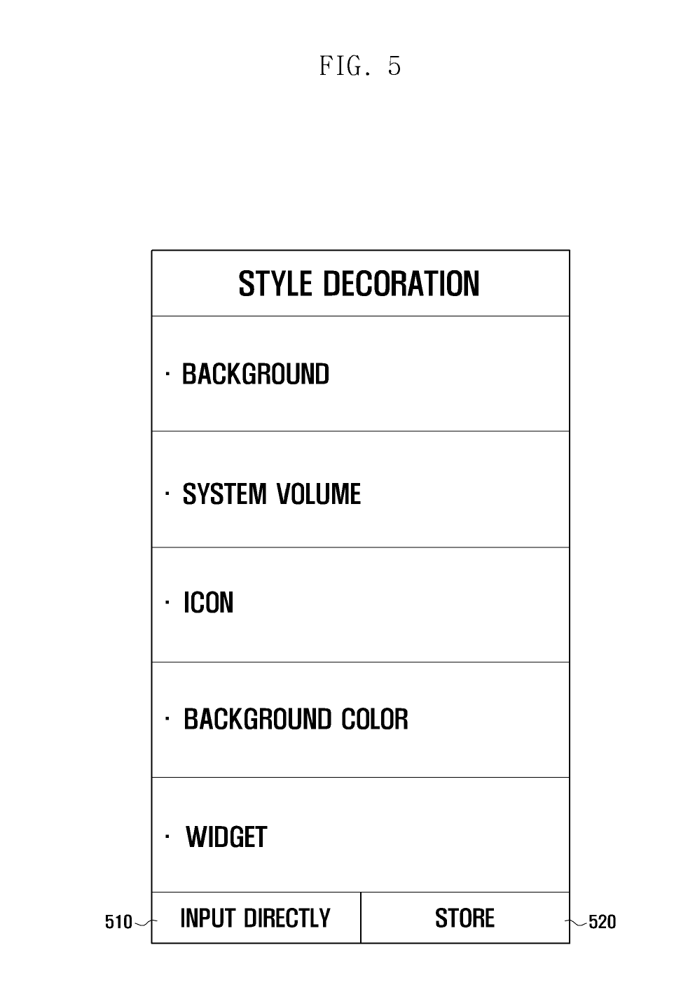

FIG. 5 illustrates a screen of a mobile device for setting a style according to an exemplary embodiment of the present invention.

Referring to FIG. 5, when a user selects the style decoration in the style hub mode, the mobile device displays a style setting window. The style decoration menu allows the user to set the environment of the mobile device. The style setting window displays a style creation menu for newly creating a style and a style registration menu for registering a stored style in a style sharing network.

When the style creation menu is selected, the mobile device displays a style creation window for setting at least one basic property forming a style. For example, as shown in FIG. 5, the style creating window includes a ‘background screen’ for setting a background screen on the mobile device, a ‘system volume’ for setting the system sound output from the mobile device, an ‘icon’ for setting icons displayed on the screen of the mobile device, a ‘background color’ for setting the background color displayed on the display unit, and a ‘widget’ for setting widgets displayed on the display unit.

The mobile device further displays, on the display unit 345, a ‘direct input’ menu 510 that allows the user to directly program codes to alter the style serving as the environment of the mobile device. The programming language may be eXtensible Markup Language (XML). In addition, the mobile device displays a ‘store’ menu 520 for storing information corresponding to styles set by the user.

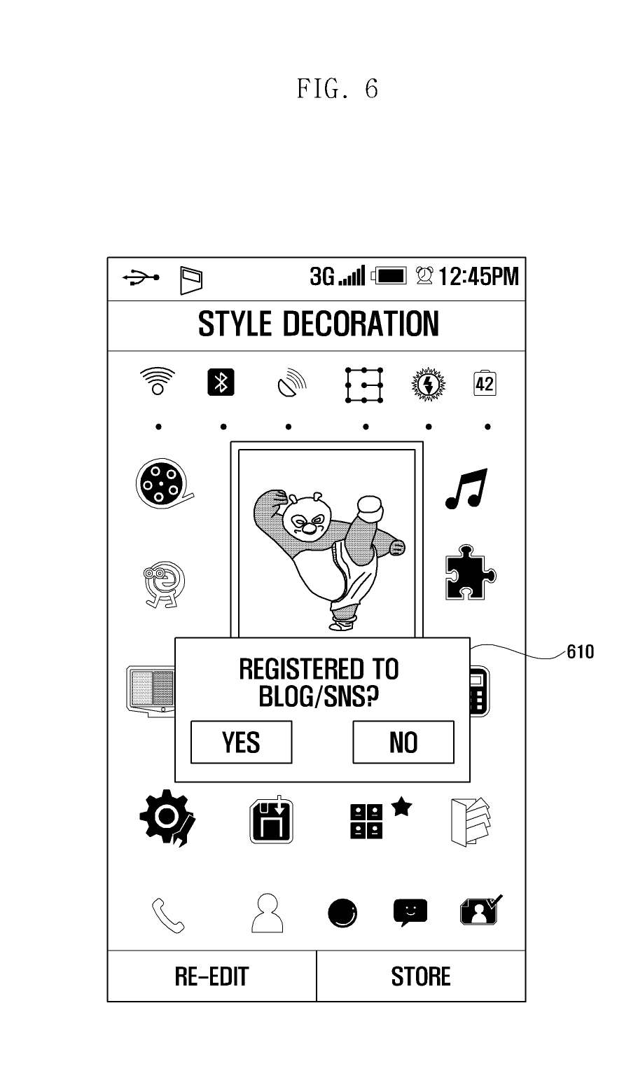

FIG. 6 illustrates a screen of a mobile device for selecting a style exhibition set in the mobile device according to an exemplary embodiment of the present invention.

Referring to FIG. 6, when a style storage menu is selected, the mobile device can register the set style in an exhibition network, according to a user's selection, so that other users can view the style. To this end, when a style storage menu has been selected, the mobile device displays an exhibition network registration selection window 610 asking the user whether to register a corresponding style in an exhibition network. The exhibition network registration selection window 610 may be implemented with a pop-up message window or an overlay window. When the user selects ‘Yes’ for registration, the mobile device connects to an exhibition network and then registers a corresponding style therein. In an exemplary embodiment of the present invention, the exhibition network is an SNS or a blog that the user manages.

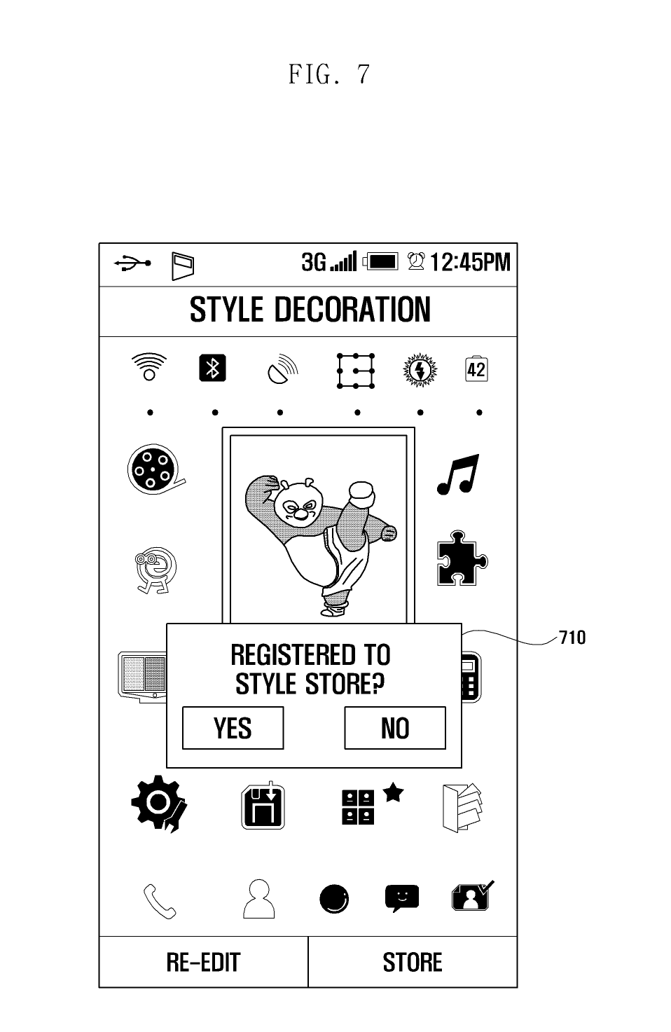

FIG. 7 illustrates a screen of a mobile device for selecting a style information upload according to an exemplary embodiment of the present invention.

Referring to FIG. 7, when a style storage menu is selected, a mobile device can register the set style in a style sharing network, according to a user's selection. To this end, when a style storage menu has been selected, the mobile device displays a registration selection window 710 asking the user whether to register corresponding style information in a style sharing network. The registration selection window 710 may be implemented with a pop-up message window or an overlay window. When the user selects ‘Yes’ for registration, the mobile device connects to a style sharing network. Thereafter, the mobile device transfers the style information to the style sharing network, together with the user's identification-information. The style sharing network stores the style information and the user's identification-information.

As described above, the mobile device can register a style set according to a user's selection in a blog/SNS or a style sharing network. When a style storage menu is selected, the mobile device first displays an exhibition network registration selection window to register a style to a blog/SNS. In addition, when the user selects a menu asking whether to register a style in an exhibition network, the mobile device displays a registration selection window to register a set style in a style sharing network. Alternatively, the mobile device may display an exhibition network registration selection message and a style sharing network registration selection message on one window. The mobile device determines whether there is an exhibition network that is previously cooperated therewith. When the mobile device determines that there is an exhibition network that is previously cooperated therewith, it can display an exhibition network registration selection window.

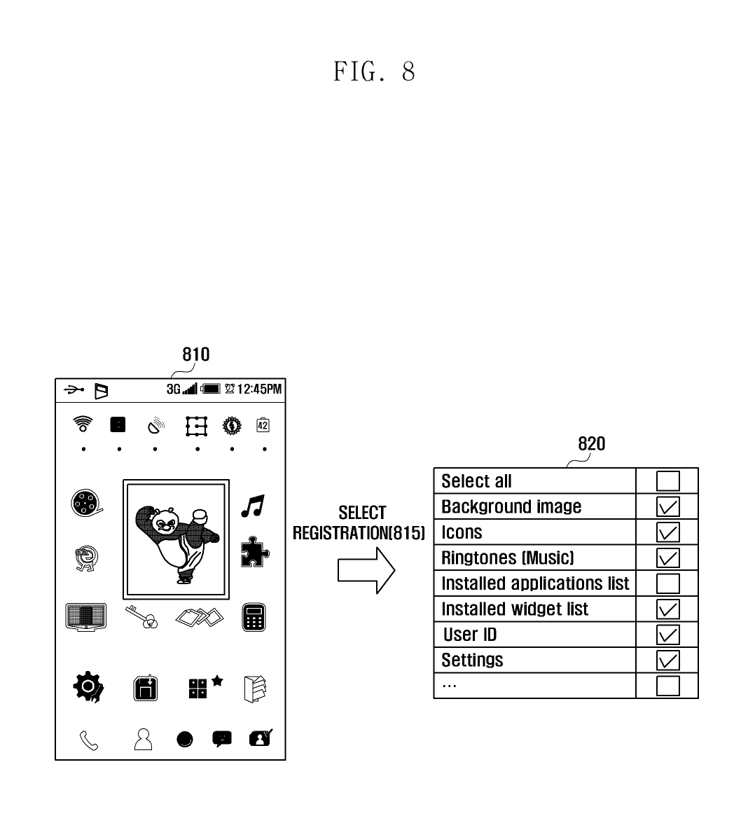

FIG. 8 illustrates a screen of a mobile device for selecting style information to be uploaded according to an exemplary embodiment of the present invention.

Referring to FIG. 8, when the mobile device registers a style in an exhibition network or a style sharing network, it can register only style information desired by the user in a style sharing network. More particularly, the mobile device displays a style 810 set according to a user's selection on the display unit. When a selection 815 is made to register style information in a style sharing network or an exhibition network, the mobile device displays style information list 820 required to display styles on the display unit. Thereafter, the mobile device may register only style information selected by the user in a corresponding network.

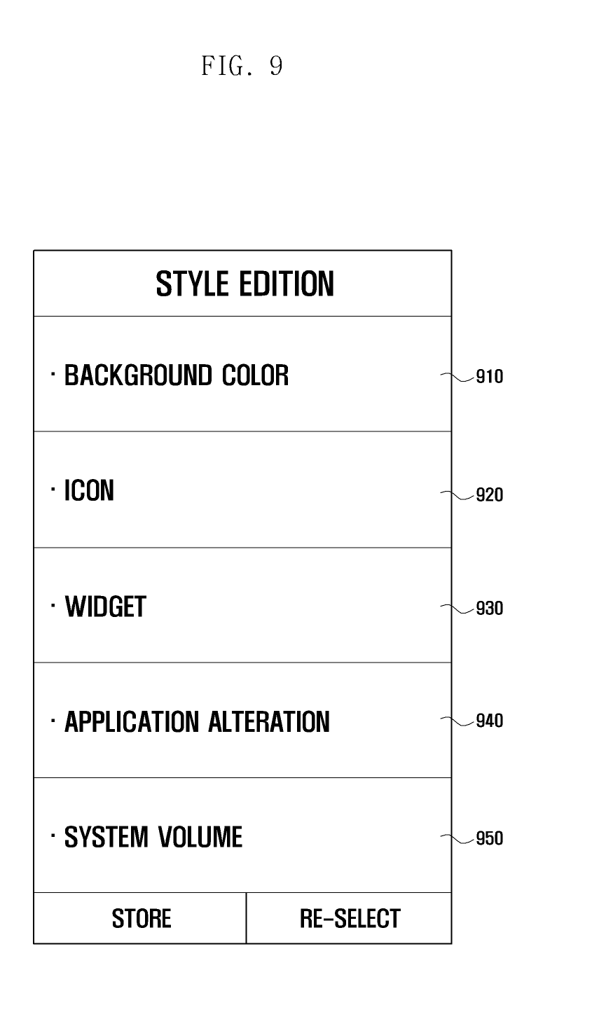

In the foregoing description, the method is described where the mobile device registers a style created by the user in a network so that it can share with other users. The following description provides a method for downloading and editing styles registered by other users, according to a user's selection, referring to FIG. 9.

FIG. 9 illustrates a screen of a mobile device for selecting a style edition according to an exemplary embodiment of the present invention.

Referring to FIG. 9, the mobile device receives style information according to a user's selection from a style sharing network. The mobile device displays a style corresponding to the received style information. When the user selects a style edit feature, the mobile device displays style edit menus to edit style information forming a style as shown in FIG. 9.

The style edit menus include a background color menu 910 for editing background color, an icon menu 920 for editing icons displayed on the background screen, a widget menu 930 for editing widgets displayed on the background screen, an application menu 940 for altering an application executed when an icon displayed on the background screen is selected, and a system volume menu 950 for adjusting the system's sound.

When one of the style edit menus is selected, the mobile device displays basic properties corresponding thereto. For example, when the user selects a background color menu 910, the mobile device displays the currently set background color and other colors available to alter the background color. The mobile device can set the background color according to a user's selected color. The mobile device can allow the user to edit the style information serving as the properties forming a style, so that he/she can recreate a downloaded style as a style that he/she wishes.

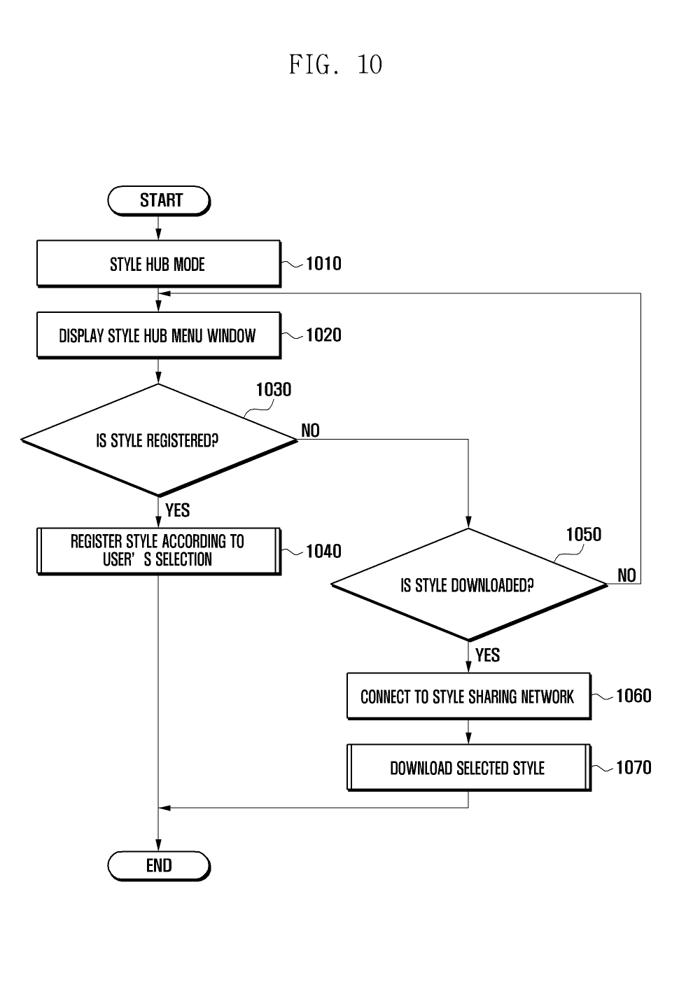

FIG. 10 is a flowchart illustrating a method for managing style information in a mobile device according to an exemplary embodiment of the present invention.

Referring to FIG. 10, the mobile device operates a style hub mode according to a user's selection at step 1010. The style hub mode refers to a mode where the environment of a mobile device is managed according to a user's selection. In the style hub mode, the mobile device can create and register styles according to a user's selection, or also download and store styles created by other users, according to a user's selection.

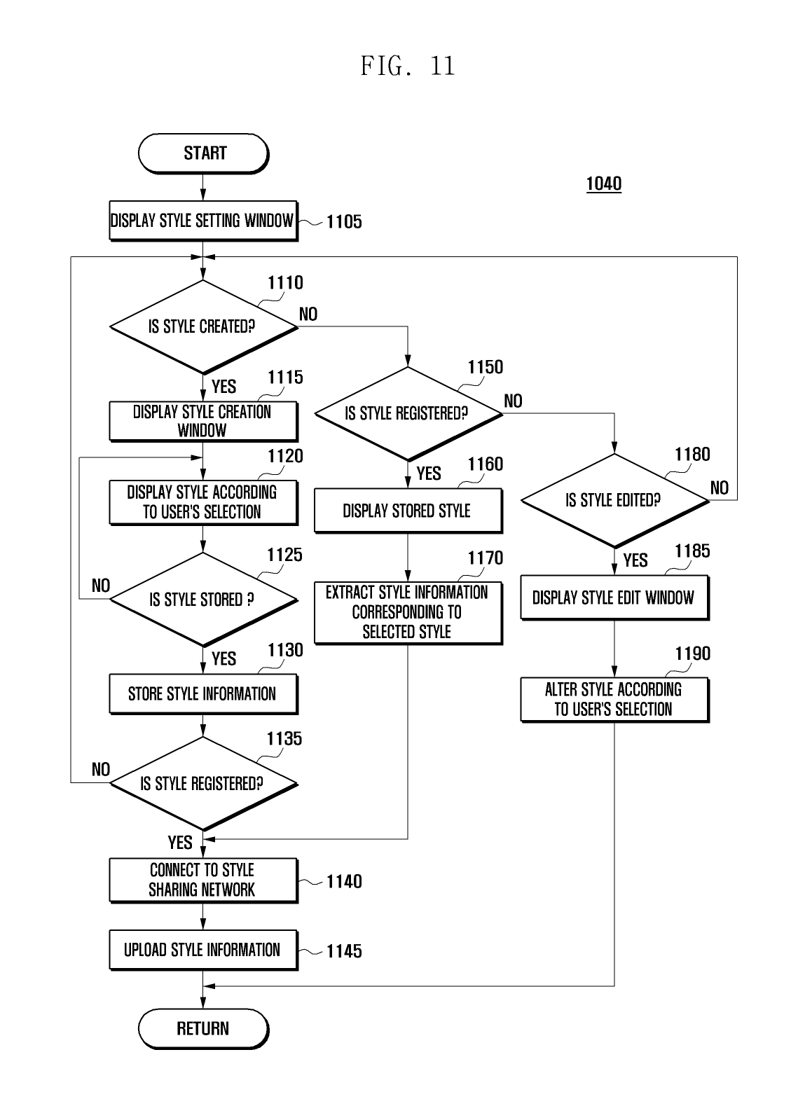

At step 1020, the mobile device displays a style hub menu window on the display unit. The style hub menu window displays at least one of a menu that allows a user to register a style to set the environment of the mobile device and a menu that allows the user to download styles registered by the other users. At step 1030, the mobile device determines whether the user selects a style registration to set the environment of the mobile device. If it is determined at step 1030 that the user selects a style registration to set the environment of the mobile device, the mobile device registers a style according to the user's selection at step 1040, which will be described later, referring to FIG. 11.

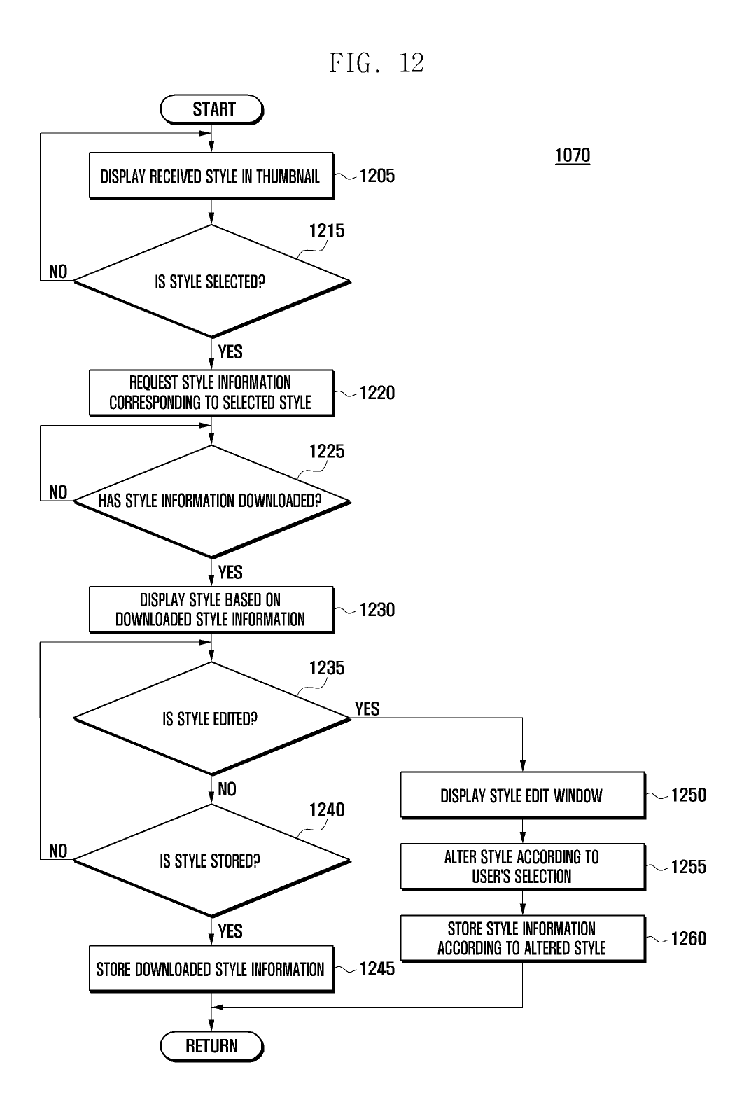

In contrast, if it is determined at step 1030 that the user does not select a style registration to set the environment of the mobile device, the mobile device determines whether the user selects a style download to download a style registered by the other user at step 1050. If it is determined at step 1050 that the user selects a style download to download a style registered by the other user, the mobile device controls the communication unit to connect to a style sharing network at step 1060. The mobile device displays at least one style, received via the communication unit from the style sharing network, on the display unit in thumbnail form. Thereafter, the mobile device downloads the user's selected style at step 1070, which will be described later, referring to FIG. 12.

FIG. 11 is a flowchart illustrating a method for setting style information in a mobile device according to an exemplary embodiment of the present invention.

Referring to FIG. 11, when a user selects a style registration, the mobile device displays a style setting window on the display unit at step 1105. The style setting window includes a style creation menu for setting a new environment in the mobile device and a style registration menu for registering style information corresponding to a stored style in a style sharing network. The style setting window also displays a style edit menu for editing stored style information or a downloaded style.

Thereafter, the mobile device determines whether a style creation menu is selected at step 1110. If it is determined at step 1110 that a style creation menu is selected, the mobile device displays a style creation window on the display unit at step 1115. The style creation window displays a background screen setting, a system volume adjustment, an icon setting, a background color setting, a widget setting, etc., in order to set style information serving as the basic properties forming the environment of the mobile device. Thereafter, the mobile device displays a style set according to a user's selection at step 1120.

At step 1125, the mobile device determines whether a style storage menu is selected. If it is determined at step 1125 that a style storage menu is selected, the mobile device stores style information regarding the basic properties forming a style in the storage unit at step 1130. Thereafter, the mobile device determines whether a style registration menu is selected at step 1135.

If it is determined at step 1135 that a style registration menu is selected, the mobile device controls the communication unit to connect to a style sharing network at step 1140. The mobile device uploads the style information stored in the storage unit to the style sharing network at step 1145. The mobile device displays a style information list to be uploaded, selected from the style information stored in the storage unit. The mobile device uploads only style information selected by the user to the style sharing network. Alternatively, the mobile device may also transfer the identification-information of a user who uploaded the style information, such as a user's identification or phone number, when uploading the style.

In contrast, if it is determined at step 1110 that a style creation menu is not selected, the mobile device determines whether a style registration menu is selected at step 1150. If it is determined at step 1150 that a style registration menu is selected, the mobile device displays at least one style, stored in the storage unit, on the display unit at step 1160. The mobile device may display at least one style in thumbnail form on the display unit.

Thereafter, the mobile device extracts the information regarding the style selected from the displayed styles, from the style information stored in the storage unit at step 1170, and proceeds with step 1140. That is, the mobile device extracts the style information and uploads it to the style sharing network connected thereto. Alternatively, although it is not shown in the drawings, the mobile device may register the set style in an exhibition network, such as a blog/SNS, according to a user's selection.

In contrast, if it is determined at step 1150 that a style registration menu is not selected, the mobile device determines whether a style edit menu is selected at step 1180. If it is determined at step 1180 that a style edit menu is selected, the mobile device displays a style edit window on the display unit at step 1185. Thereafter, the mobile device alters the style according to a user's selection at step 1190. More specifically, when a style edit menu is selected, the mobile device displays information regarding a style that is currently set or is selected by the user. That is, the mobile device extracts style information serving as the basic property forming the environment of the mobile device and displays them in the list. Thereafter, the mobile device alters style information according to a user's selection. The mobile device displays styles according to the altered style information on the display unit. Thereafter, the mobile device stores the style information altered according to the user's selection in the storage unit.

FIG. 12 is a flowchart illustrating a method for downloading style information in a mobile device according to an exemplary embodiment of the present invention.

Referring to FIG. 12, the mobile device receives at least one style via a style sharing network connected thereto and displays it in thumbnail form on the display unit at step 1205. The mobile device determines whether the user selects one of the styles displayed on the display unit at step 1215. If it is determined at step 1215 that the user selects one of the styles displayed on the display unit, the mobile device requests information corresponding to the selected style from the style sharing network via the communication unit at step 1220. When the mobile device receives the style information from the style sharing network, it determines whether the style information has been completely downloaded at step 1225.

If it is determined at step 1225 that the style information has been completely downloaded, the mobile device displays the style based on the downloaded style information on the display unit at step 1230. The mobile device identifies information regarding a paid application to be downloaded, from the style information. The mobile device displays, on the display unit, the downloaded style and the amount of money to be paid when the paid application is downloaded from an APP store. Alternatively, the mobile device determines whether it has installed applications thereto that are the same as the paid applications to be downloaded. When the mobile device determines that it has installed applications thereto that are the same as the paid applications to be downloaded, it downloads the paid applications except for the same applications, and displays, on the display unit, the downloaded styles and the amount of money paid when they are downloaded. The mobile device may display, on the display unit, the icons corresponding to the paid applications, distinguishing the other icons.

At step 1235, the mobile device determines whether a style edit menu is selected. If it is determined at step 1235 that a style edit menu is not selected, the mobile device determines whether a style storage menu is selected at step 1240. If it is determined at step 1240 that a style storage menu is selected, the mobile device stores the downloaded style information at step 1245. The mobile device may store only style information selected by the user. More particularly, when the user selects a style storage menu, the mobile device displays information forming a style in the list. Thereafter, the mobile device may store only style information selected by the user in the storage unit. The mobile device downloads paid applications from among the style information selected by the user from a corresponding APP store, and stores them.

In contrast, if it is determined at step 1235 that a style edit menu is selected, the mobile device displays a style edit window on the display unit at step 1250. The mobile device alters the style according to a user's selection at step 1255. That is, the mobile device displays, on the display unit, style information corresponding to an edit menu selected from the menu items in the style edit window according to a user's selection. Thereafter, the mobile device displays the style information edited according to a user's selection on the display unit. The mobile device stores the style information corresponding to the altered style in the storage unit at step 1260.

In the foregoing description, a method is described that sets the environment of the mobile device according to a style selected by the user or downloads styles registered by the other users. The following description explains a method for providing a style sharing network.

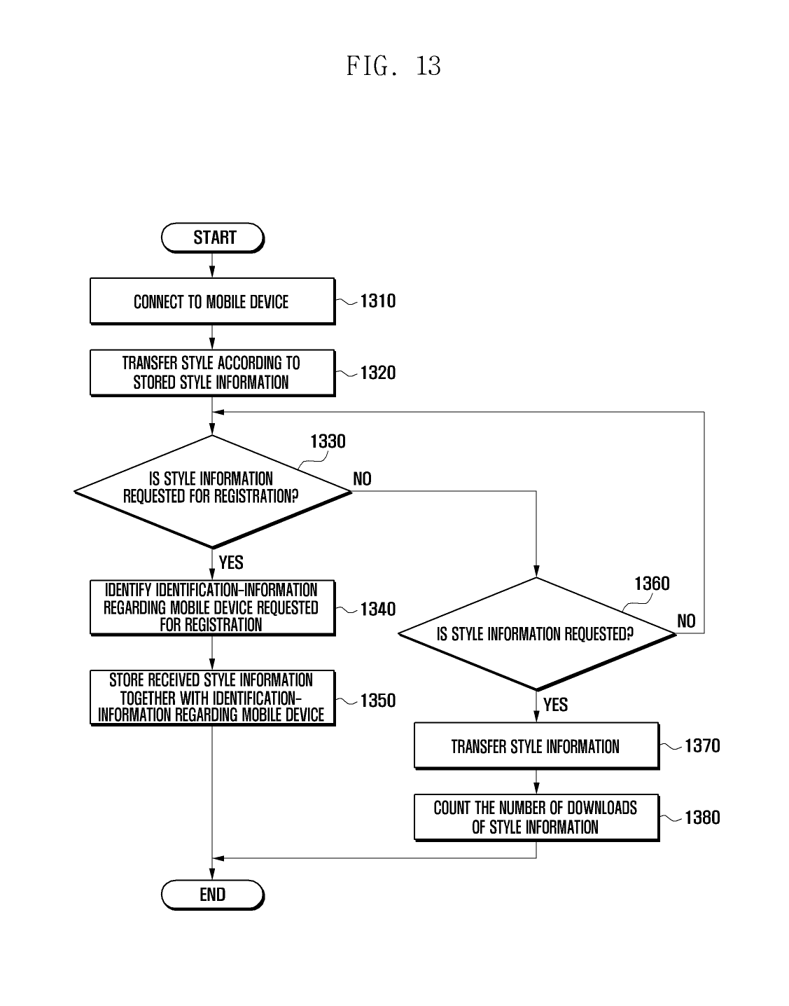

FIG. 13 is a flowchart illustrating a method for managing style information in a style sharing network according to an exemplary embodiment of the present invention.

Referring to FIG. 13, a style sharing network is connected to a mobile device that requested connection at step 1310. The style sharing network transfers styles according to stored style information, in thumbnail form, to the mobile device at step 1320. The style sharing network transfers, to the mobile device, the styles sorted according to the number of downloads or according to the registered dates.

At step 1330, the style sharing network determines whether it receives a request for style information registration from the mobile device. When the style sharing network receives a request for style information registration from the mobile device at step 1330, it identifies a user's identification-information of the mobile device that requested for registration at step 1340. The user's identification-information may be user's IDs, phone numbers or IP addresses allocated to mobile device respectively. The style sharing network stores the style information transferred from the mobile device and the user's identification-information of the mobile device at step 1350.

In contrast, when the style sharing network does not receive a request for style information registration from the mobile device at step 1330, it determines whether the mobile device requests style information at step 1360. When the style sharing network determines that the mobile device requests style information at step 1360, it transfers the requested style information to the mobile device at step 1370. The style sharing network may further transfer, to the mobile device, the link information and the information regarding the amount of money for the paid application included in the style information.

Thereafter, the mobile device counts and stores the number of downloads of corresponding style information at step 1380. The number of downloads of corresponding style information is used to divide the rewards into users who registered corresponding styles. The style sharing network may be implemented in such a manner to be included in an APP store or separated therefrom. Alternatively, the style sharing network may be implemented in such a manner as to cooperate with the APP store.

As described above, the information managing method and the mobile device adapted thereto can allow users to easily alter the environment of the mobile device including applications. The information managing method and the mobile device can also allow users to edit a corresponding one of the environments of the mobile devices set by other users to a desired environment. In addition, users can download applications included in the other user's edited style to their mobile devices, without having to search for their desired applications one by one.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for managing information in a mobile device, the method comprising:
creating, when the mobile device operates a style hub mode to manage a style serving as an environment of the mobile device, at least one piece of style information serving as a basic property forming the style;
displaying a style corresponding to the created style information; and
uploading, when a style registration is selected, style information corresponding to the displayed style to a style sharing network connected to the mobile device.

2. The method of claim 1, wherein the creation of the at least one piece of style information comprises:
displaying, when a style download is selected, at least one style transferred from the style sharing network;
requesting style information corresponding to one selected style from at least one or more styles displayed from the style sharing network; and
downloading the requested style information.

3. The method of claim 1, wherein the uploading of the style information comprises:
displaying the created style information in a list; and
uploading the style information, selected from the created style information in the list, to the style sharing network.

4. The method of claim 1, wherein the uploading of the style information comprises:
transferring at least one of a user's identification, a phone number, and an Internet Protocol (IP) address of the mobile device, together with the created style information.

5. The method of claim 2, wherein the downloading of the requested style information comprises:
displaying, when a style edit is selected, a style edit window for editing the style information; and
editing and storing the style information selected from the style edit window.

6. The method of claim 2, wherein the downloading of the requested style information comprises:
identifying a paid application included in the style information; and
displaying the amount of money paid when the identified paid application is downloaded.

7. The method of claim 2, wherein the downloading of the requested style information comprises:
displaying the downloaded styles in thumbnail form.

8. The method of claim 1, wherein the uploading of the style information comprises:
registering the style in an exhibition network cooperating with the mobile device, in order to inform other users of the style information.

9. The method of claim 1, wherein the style information comprises:
information corresponding to at least one of a background screen, a menu, a widget, an icon, and a system volume.

10. The method of claim 2, wherein the uploading of the style information comprises:
uploading a user's identification-information for the mobile device.

11. A mobile device comprising:
a controller for creating, when the mobile device operates a style hub mode to manage a style serving as an environment of the mobile device, at least one piece of style information forming the style, and for uploading, when a style registration is selected, the created style information to a style sharing network connected to the mobile device;
a communication unit for connecting to the style sharing network under the control of the controller;
a storage unit for storing the style information under the control of the controller; and
a display unit for displaying a style corresponding to the style information under the control of the controller.

12. The mobile device of claim 11, wherein the controller controls the display unit to display the created style information in the list, and controls the communication unit to upload style information, selected from the created style information in the list, to the style sharing network.

13. The mobile device of claim 11, wherein the controller transfers at least one of a user's identification, a phone number, and an Internet Protocol (IP) address of the mobile device, together with the created style information.

14. The mobile device of claim 12, wherein the controller displays, when a style download is selected, at least one style, received via the communication unit from the style sharing network, on the display unit, controls the communication unit to request style information corresponding to one selected style from at least one or more styles displayed from the style sharing network, and downloads the requested style information.

15. The mobile device of claim 14, wherein the controller controls, when a style edit is selected, the display unit to display a style edit window for editing the style information, edits the style information selected from the style edit window, and stores the style information in the storage unit.

16. The mobile device of claim 14, wherein the controller identifies a paid application included in the style information, and displays, on the display unit, the amount of money paid when the identified paid application is downloaded.

17. The mobile device of claim 14, wherein the controller displays the downloaded styles on the display unit in thumbnail form.

18. The mobile device of claim 11, wherein the controller controls the communication unit to connect to an exhibition network cooperating with the mobile device, in order to inform the other users of the style information, and registers the style information in the exhibition network.

19. The mobile device of claim 11, wherein the style information comprises information corresponding to at least one of a background screen, a menu, a widget, an icon, and a system volume.

20. The mobile device of claim 12, wherein the controller controls the communication unit to upload a user's identification-information of the mobile device in the style sharing network.
